(19) United States
(12) Patent Application Publication
(10) Pub. No.: US 2007/0106946 A1
(43) Pub. Date: May 10, 2007

(54) Method and system for developing interactive Web applications in a unified framework

(76) Inventors: Philip Goetz, Brooklyn, NY (US); Clay Gordon, Larchmont, NY (US); Asher Snyder, Brooklyn, NY (US); Philip Ross, Brooklyn, NY (US)

Correspondence Address: MCDERMOTT WILL & EMERY LLP, 600 13TH STREET, N.W., WASHINGTON, DC, 20005-3096, US

(21) Appl. No.: 11/267,571

(22) Filed: Nov. 7, 2005

(51) Int. Cl. G06F 3/00

(52) U.S. Cl. 715/744

(57) ABSTRACT

The present invention discloses a method and system for developing and operating interactive Web applications in a unified, light-weight, on-demand, modular server application framework. The present invention provides a novel unified approach utilizing a single programming language to develop interactive Web applications. The modular Web applications of the present invention operate at the server-side. The Web application of the present invention comprises one or more Web application modules written entirely in a scripting programming language. The Web application modules are interpreted and executed by the scripting language interpreter engine to generate all of the code necessary, such as the HTML and JavaScript code, to service the requests from the clients. Unlike existing server-based integrated solutions, however, the present invention does not require the entire Web application to be loaded at all times to be operational. The Web application modules of the present invention are loaded and executed on-demand as required by requests from the Web clients, thus requiring much less computing resource overhead than existing integrated server-based solutions. The result is a unified approach that provides a single programming language framework for developing interactive Web applications that is light weight, modular, and flexible.

### BACKGROUND OF THE INVENTION

1. Field of the Invention

The present relates to a method and system for developing and operating Web applications. Specifically, the present invention relates to a method and system for developing and operating interactive Web applications in a unified, light-weight, on-demand, modular server application framework.

2. Description of the Related Art

The growth of popularity of the Internet is largely due to the World Wide Web. The key components of the early World Wide Web technology are: 1) HTML (hyper text markup language), which is a standard for specifying hypertext links and formatting text for presentation; 2) HTTP (hypertext transfer protocol), a network communication protocol for communicating data between a user computer and a server; 3) HTTP server, a program for receiving requests from the user computer and transmitting the requested information; and 3) Web Browser, a program for viewing HTML text source file (a Web page) and navigating hypertext links. Typically, the HTTP server program ran at a server computer (a Web server) where the Web pages are also stored, and the Web Browser programs were used by users at the user computers (Web clients). The Browser and the HTTP server communicated over the Internet so that information can be published, accessed, and shared instantly around the world.

FIG. 1 illustrates the operation of the traditional World Wide Web. A user at a user computer 100 click on a link 110 on a Web page 112 presented by the Web browser program 120. The request for a new Web page specified by the link 110 is transmitted over the Internet to the HTTP server program 130 running at a Web server computer 140. The HTTP server 130 locates the requested file (a Web page) 150, which is written in HTML, and transmits the file to the user computer 100 over the Internet. The Web browser 120 receives the transmitted file, renders the HTML code in the file, and displays the Web page on the user computer 100.

Because the original World Wide Web was designed mainly to exchange documents, the early Web pages were not interactive in a way a graphics design program is interactive. More importantly, the building blocks of the original Web model—i.e., the HTML language, the HTTP protocol, the HTTP server, and the Web browser—had little capacity (i.e., programming ability) to support interactive applications such as the graphical interactive programs. As the demand for interactive applications on the Web grew, several technologies were introduced to make the Web pages more interactive—for example, JavaScript for programming at the Web browser or the client side; Perl, Tcl, ASP, PHP, and Java for programming at the Web server side; Active X and .NET for reusable interactive components; and various database interfaces to store the interactive state information. Although these technologies have been highly successful in creating sophisticated, interactive Web sites or Web applications, this approach has also led to considerable complexity and difficulty in designing and developing sophisticated interactive Web applications.

Typically, designing and developing an interactive Web application or Web site nowadays involves programming in several programming languages at the server side and the client side, designing visual user interface and “look and feel”, designing HTML pages, and putting the disparate parts all together to create a functional user application. It is a highly complex process that is difficult to manage in a coherent fashion. Currently, there exist technologies or solutions that address this problem such as the Java 2 Enterprise Edition (J2EE) or IBM WebSphere Application Server. See, e.g., http://java.sun.com/j2ee for J2EE, and http://www-306.ibm.com/software/webservers/appserv/was/features/ for IBM WebSphere Application Server. An Application Server is a special purpose server-based software that handles all of the application functions and client requests within a single software framework. As such, both the J2EE and Application Server solutions operate by loading the entire application at the server computer at all times. Consequently, such monolithic architecture solutions require a large overhead of computing resources even for relatively simple functions or tasks. Thus, the J2EE and Application Server technologies are heavy-weight approaches that may not be suitable for situations where a large computing resource overhead is not appropriate or even feasible.

It can be seen, then, there is a need in the field of interactive Web applications for a more flexible, light-weight, yet consolidated approach to develop and operate interactive Web applications.

### SUMMARY OF THE INVENTION

Accordingly, the present invention addresses the foregoing need by providing a method and a system for developing and operating interactive Web applications in a unified, light-weight, on-demand, modular server application framework.

In one aspect of the present invention, the entire interactive Web application is developed in a single programming language. In a preferred embodiment, the programming language is the NOLOH (acronym for Not One Line Of HTML) programming language. According to the present invention, programmers develop entire Web applications in a single programming language by writing in the same programming language one or more Web application modules that comprise the Web application. The Web application according to the present invention runs on the server side. However, the entire Web application is not required to be loaded at the application server at all times to be operational. The Web application modules are loaded on-demand at the application server based on the requests from the clients. The loaded Web application modules are interpreted and executed by the scripting language interpreter engine to generate all of the code, such as the HTML and JavaScript code, necessary to service the request from the client. Because the Web application modules are loaded on-demand as required, much less computing resources are required compared to the existing monolithic solutions such as the J2EE and special purpose Application Servers which require the entire applications to be loaded and running at all times. As a result, the present invention provides a unified single programming language framework for developing interactive Web applications that is light weight, modular, and flexible.

According to one aspect of the invention, the present invention is a system for developing interactive Web applications in a unified, single programming language framework including a scripting language, a scripting language interpreter engine for interpreting and executing code written in the scripting language, and means for writing a modular Web application comprising one or more Web application modules written entirely in the scripting language, where the modular Web application modules are loaded and executed on-demand by the scripting language interpreter engine at a Web application server to generate Web pages in response to Web page requests from a HTTP server. In one embodiment, the scripting language is an object-oriented language. In a preferred embodiment, the programming language is the NOLOH programming language.

According to another aspect of the invention, the present invention is a system for operating interactive Web applications including a scripting language interpreter engine at a Web application server for interpreting and executing code written in a scripting language, and a modular Web application comprising one or more Web application modules written entirely in the scripting language, where the scripting language interpreter engine loads, interprets, and executes the Web application modules on-demand to generate Web pages in response to Web page requests from a HTTP server.

According to yet another aspect of the invention, the present invention is a method for developing interactive Web applications in a unified single programming language framework, the method including providing a scripting language, providing a scripting language interpreter engine at a Web application server, and writing a Web application comprising one or more Web application modules written entirely in the scripting language, where the Web application modules are loaded and executed on-demand by the scripting language interpreter engine at the Web application server to generate Web pages in response to Web page requests from a HTTP server.

According to another aspect of the invention, the present invention is a method for operating an interactive Web application including loading a scripting language interpreter engine at a Web application server for interpreting and executing code written in a scripting language, loading a first Web application module at the Web application server wherein the first Web application module is written entirely in the scripting language, forwarding a request for a Web page from a HTTP server to the first Web application module, interpreting and executing with the scripting language interpreter engine script code within the first Web application module for handling the request for a Web page, generating a first Web page in response to the request for a Web page from the HTTP server, sending the generated first Web page to the HTTP server which then transmits the first Web page to a Web browser at a Web application client, generating based on a first user input a client event within the first Web page at the Web application client, servicing the client event at the Web application client, generating based on a second user input a server event within the first Web page at the Web application client, sending the server event to the HTTP server, forwarding the server event from the HTTP server to the first Web application module at the Web application server, interpreting and executing with the scripting language interpreter engine script code within the first Web application module for handling the server event, loading a second Web application module at the Web application server on-demand as required by the interpreted script code, wherein the second Web application module is written entirely in the scripting language, generating a second Web page at the Web application server in response to the server event, and sending the generated second Web page to the HTTP server which then transmits the second Web page to the Web application client.

According to yet another aspect of the invention, the present invention is an application server for generating a Web page including an interpreter engine capable of receiving a request for the Web page and in response thereto loading on-demand an appropriate Web application module, which is a computer program coded in a scripting language which is the same scripting language interpreted by the interpreter engine, where the interpreter engine executes the Web application module and does so by interpreting the scripting language code such that different types of code are pulled together to generate the requested Web page.

According to another aspect of the invention, the present invention is a method for generating a Web page including receiving a request for the Web page as an interpreter engine running at an application server, loading on-demand an appropriate Web application module based on said request wherein the Web application module is a computer program coded in a scripting language which is the same scripting language interpreted by the interpreter engine, and executing the Web application module by interpreting the scripting language code such that different types of code are pulled together to generate the requested Web page.

According to yet another aspect of the invention, the present invention is a system for operating an interactive Web application including means for loading a scripting language interpreter engine at a Web application server for interpreting and executing code written in a scripting language, means for loading a first Web application module at the Web application server wherein the first Web application module is written entirely in the scripting language, means for forwarding a request for a Web page from a HTTP server to the first Web application module, means for interpreting and executing with the scripting language interpreter engine script code within the first Web application module for handling the request for a Web page, means for generating a first Web page in response to the request for a Web page from the HTTP server, means for sending the generated first Web page to the HTTP server which then transmits the first Web page to a Web browser at a Web application client, means for generating based on a first user input a client event within the first Web page at the Web application client, means for servicing the client event at the Web application client, means for generating based on a second user input a server event within the first Web page at the Web application client, means for sending the server event to the HTTP server, means for forwarding the server event from the HTTP server to the first Web application module at the Web application server, means for interpreting and executing with the scripting language interpreter engine script code within the first Web application module for handling the server event, means for loading a second Web application module at the Web application server on-demand as required by the interpreted script code, wherein the second Web application module is written entirely in the scripting language, means for generating a second Web page at the Web application server in response to the server event, and means for sending the generated second Web page to the HTTP server which then transmits the second Web page to the Web application client.

According to another aspect of the invention, the present invention is a Computer-executable process steps for operating an interactive Web application, where the process steps are stored on a computer-readable medium, including a step for loading a scripting language interpreter engine at a Web application server for interpreting and executing code written in a scripting language, a step for loading a first Web application module at the Web application server wherein the first Web application module is written entirely in the scripting language, a step for forwarding a request for a Web page from a HTTP server to the first Web application module, a step for interpreting and executing with the scripting language interpreter engine script code within the first Web application module for handling the request for a Web page, a step for generating a first Web page in response to the request for a Web page from the HTTP server, a step for sending the generated first Web page to the HTTP server which then transmits the first Web page to a Web browser at a Web application client, a step for generating based on a first user input a client event within the first Web page at the Web application client, a step for servicing the client event at the Web application client, a step for generating based on a second user input a server event within the first Web page at the Web application client, a step for sending the server event to the HTTP server, a step for forwarding the server event from the HTTP server to the first Web application module at the Web application server, a step for interpreting and executing with the scripting language interpreter engine script code within the first Web application module for handling the server event, a step for loading a second Web application module at the Web application server on-demand as required by the interpreted script code, wherein the second Web application module is written entirely in the scripting language, a step for generating a second Web page at the Web application server in response to the server event, and a step for sending the generated second Web page to the HTTP server which then transmits the second Web page to the Web application client.

According to another aspect of the invention, the present invention is a computer program product including code for running an interpretation engine at an application server, where the engine has at least a language interpreter for a first scripting language, code for receiving a request for a Web page and in response loading on-demand a Web application module that is coded using the same first scripting language, and code for executing the Web application module and interpreting the scripting language code such that different types of code are pulled together to generate the requested Web page.

According to yet another aspect of the invention, the present invention is a computer program including code to be executed on a computer for generating a Web page, the computer program having code for loading on-demand an appropriate Web application module depending on a request received for the Web page, and executing the loaded Web application module, where the execution is arranged to pull together different types of computer code for generating the Web page.

According to another aspect of the invention, the present invention is a method for generating a Web page including at least a JavaScript module, where the JavaScript module code is hidden from view, including receiving a request for a Web page from a Web client as an interpreter engine running at an application server, loading on-demand an appropriate Web application module based on the request where the Web application module is a computer program coded in a scripting language which is the same scripting language interpreted by the interpreter engine, executing the Web application module by interpreting the scripting language code such that different types of code are pulled together to generate the requested Web page, including at least a hidden IFrame, sending the requested Web page to the Web client, loading the Web page at the Web client, requesting JavaScript code from the hidden IFrame at the Web client to the application server, receiving the request for JavaScript code from the Web client at the interpreter engine running at the application server, determining at the interpreter engine the request is for JavaScript code from the hidden IFrame at the Web client, sending the requested JavaScript code to the Web client, receiving the requested JavaScript code at the Web client, sending the requested JavaScript code to the Web page, wherein the JavaScript code is loaded into memory, and, after the requested JavaScript code has been loaded into the memory of the Web page, deleting the JavaScript code from the hidden IFrame at the Web client.

According to yet another aspect of the invention, the present invention is a system for generating a Web page including at least a JavaScript module, where the JavaScript module code is hidden from view, including means for receiving a request for a Web page from a Web client as an interpreter engine running at an application server, means for loading on-demand an appropriate Web application module based on said request wherein the Web application module is a computer program coded in a scripting language which is the same scripting language interpreted by the interpreter engine, means for executing the Web application module by interpreting the scripting language code such that different types of code are pulled together to generate the requested Web page, including at least a hidden IFrame, means for sending the requested Web page to the Web client, means for loading the Web page at the Web client, means for requesting JavaScript code from the hidden IFrame at the Web client to the application server, means for receiving the request for JavaScript code from the Web client at the interpreter engine running at the application server, means for determining at the interpreter engine the request is for JavaScript code from the hidden IFrame at the Web client, means for sending the requested JavaScript code to the Web client, means for receiving the requested JavaScript code at the Web client, means for sending the requested JavaScript code to the Web page, where the JavaScript code is loaded into memory, and means for deleting the JavaScript code from the hidden IFrame at the Web client after the requested JavaScript code has been loaded into the memory of the Web page.

According to another aspect of the invention, the present invention is computer-executable process steps for generating a Web page including at least a JavaScript module, where the JavaScript module code is hidden from view, and where the process steps are stored on a computer-readable medium, including a step for receiving a request for a Web page from a Web client as an interpreter engine running at an application server, a step for loading on-demand an appropriate Web application module based on said request wherein the Web application module is a computer program coded in a scripting language which is the same scripting language interpreted by the interpreter engine, a step for executing the Web application module by interpreting the scripting language code such that different types of code are pulled together to generate the requested Web page, including at least a hidden IFrame, a step for sending the requested Web page to the Web client, a step for loading the Web page at the Web client, a step for requesting JavaScript code from the hidden IFrame at the Web client to the application server, a step for receiving the request for JavaScript code from the Web client at the interpreter engine running at the application server, a step for determining at the interpreter engine the request is for JavaScript code from the hidden IFrame at the Web client, a step for sending the requested JavaScript code to the Web client, a step for receiving the requested JavaScript code at the Web client, a step for sending the requested JavaScript code to the Web page, where the JavaScript code is loaded into memory, and a step for deleting the JavaScript code from the hidden IFrame at the Web client after the requested JavaScript code has been loaded into the memory of the Web page.

According to yet another aspect of the invention, the present invention is a computer program product for generating a Web page including at least a JavaScript module, where the JavaScript module code is hidden from view, including code for receiving a request for a Web page from a Web client as an interpreter engine running at an application server, code for loading on-demand an appropriate Web application module based on said request wherein the Web application module is a computer program coded in a scripting language which is the same scripting language interpreted by the interpreter engine, code for executing the Web application module by interpreting the scripting language code such that different types of code are pulled together to generate the requested Web page, including at least a hidden IFrame, code for sending the requested Web page to the Web client, code for loading the Web page at the Web client, code for requesting JavaScript code from the hidden IFrame at the Web client to the application server, code for receiving the request for JavaScript code from the Web client at the interpreter engine running at the application server, code for determining at the interpreter engine the request is for JavaScript code from the hidden IFrame at the Web client, code for sending the requested JavaScript code to the Web client, code for receiving the requested JavaScript code at the Web client, code for sending the requested JavaScript code to the Web page, wherein the JavaScript code is loaded into memory, and code for deleting the JavaScript code from the hidden IFrame at the Web client after the requested JavaScript code has been loaded into the memory of the Web page.

Other and further objects and advantages of the present invention will be further understood and appreciated by those skilled in the art by reference to the following specification, claims, and drawings.

### BRIEF DESCRIPTION OF THE DRAWINGS

Referring now to the drawings in which like reference numbers represent corresponding parts throughout:

FIG. 1 illustrates the operation of the traditional World Wide Web;

FIG. 2 illustrates a system for operating an interactive Web application according to the present invention;

FIG. 3 illustrates another system for operating an interactive Web application according to the present invention;

FIG. 4 illustrates the file and class structure of an interactive Web application according to the present invention

FIG. 5 illustrates the operation of the scripting language interpreter engine according to the present invention; and

FIG. 6 illustrates the JavaScript hiding function according to the present invention.

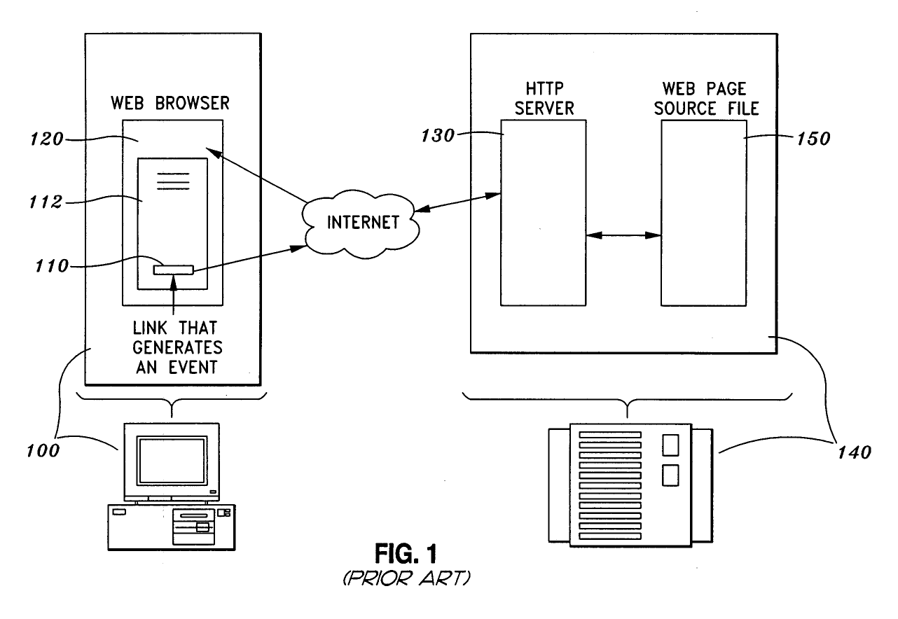

### DETAILED DESCRIPTION OF THE INVENTION

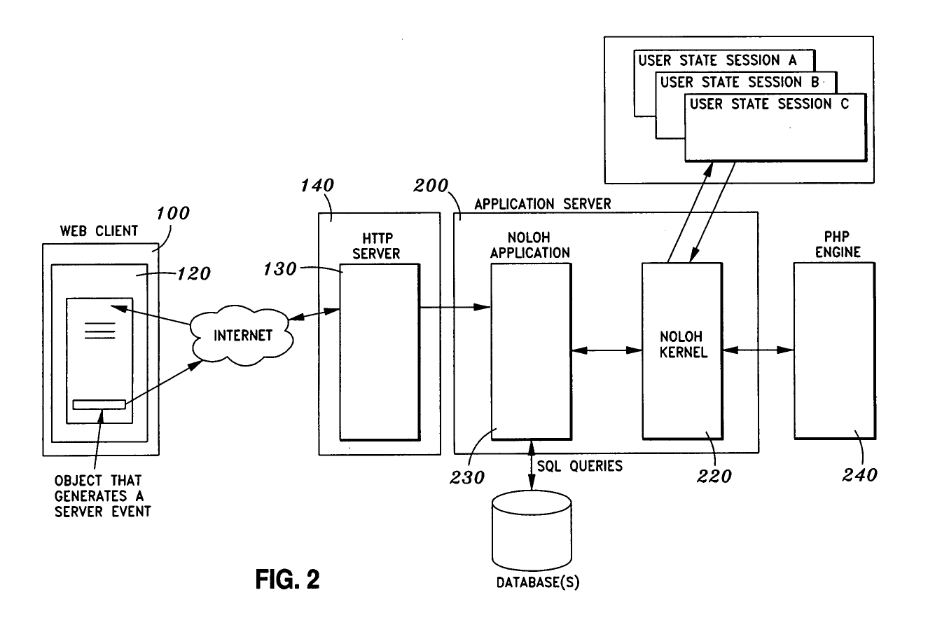

FIG. 2 illustrates a system for operating an interactive Web application according to the present invention. As shown in FIG. 2, the system comprises a user computer or Web Client computer 100, a Web Browser program 120, a Web Server computer 140, a HTTP Server program 130, a Web Application Server computer 200, a scripting language interpreter engine 220 for interpreting and executing code written in a scripting language, a modular Web application 230 comprising one or more Web application modules written entirely in the scripting language.

The modular Web application 230 according to the present invention runs on the server-side—that is, on the Web Application Server computer 200. The scripting language interpreter engine 220 includes a scripting language interpreter to interpret program code written in the scripting language and an execution environment to execute the interpreted program code. The scripting language interpreter engine 220 runs on the Web Application Server computer 200. The HTTP Server program 130 runs on the Web Server computer 140. The Web Server computer 140 and the Web Application Server computer 200 can be the same physical machine without departing from the scope of the present invention. The Web Browser program 120 runs on the user computer or Web Client computer 100.

Initially, the Web Browser program 120 may send a request for a default page or home page to the HTTP Server program 130 running at the Web Server computer 140. As is well-known in the art, a Web page at a computer is identified by the URL (Uniform Resource Locator) specified by the user at the Web Browser program 120. With help from the Domain Name System and the IP router network, the request for a Web page is routed to the HTTP Server program 130 running at the Web Server computer 140. According to the present invention, however, when the HTTP Server program 130 receives a request for a home page or a default page from the Web Browser program 120, the HTTP Server program 130 forwards the request to the scripting language interpreter engine 220 instead of attempting to locate the Web page on its own. The scripting language interpreter engine 220 then loads an appropriate Web application module which is written entirely in the script programming language. The Web application module is interpreted and executed by the scripting language interpreter engine 220, generating the appropriate Web page. The Web application module written in the scripting language pulls together all of the files and code necessary to generate the requested page, including the HTML source file, graphic files, and JavaScript program code. The generated Web page is then sent to the HTTP Server program 130, which in turn transmits it to the Web Browser program 120 running at the Web Client computer 100. The Web Browser program 120 renders various code contained in the Web page and displays the Web page on the Web Client computer 100.

The rendered Web page may contain passive components such as text and graphics, as well as active components such as the hypertext links, form fields, buttons, tabs, and menus. The Web page may also contain program code such as JavaScript modules. When the user interact with the Web page via any one of the active components an event is generated. Some of the events are client events where the user request can be handled within the client environment without forwarding the request to the server. These client events are handled by JavaScript code within the Web page memory.

The server events that require response from the server are sent to the HTTP Server program 130 via the Internet. The HTTP Server program 130 then forwards the event to the scripting language interpreter engine 220. Upon receiving the server event, the scripting language interpreter engine 220 loads the appropriate Web application module, also written entirely in the scripting programming language, to perform the requested service. For example, the requested service may require a new Web page. Then, the Web application module pulls together all of the files and code necessary to generate the requested page, including the HTML source file, graphic files, and JavaScript program code. The generated Web page is then sent to the HTTP Server program 130, which in turn transmits it to the Web Browser program 120 running at the Web Client computer 100. The Web Browser program 120 renders various code contained in the Web page and displays the new Web page on the Web Client computer 100.

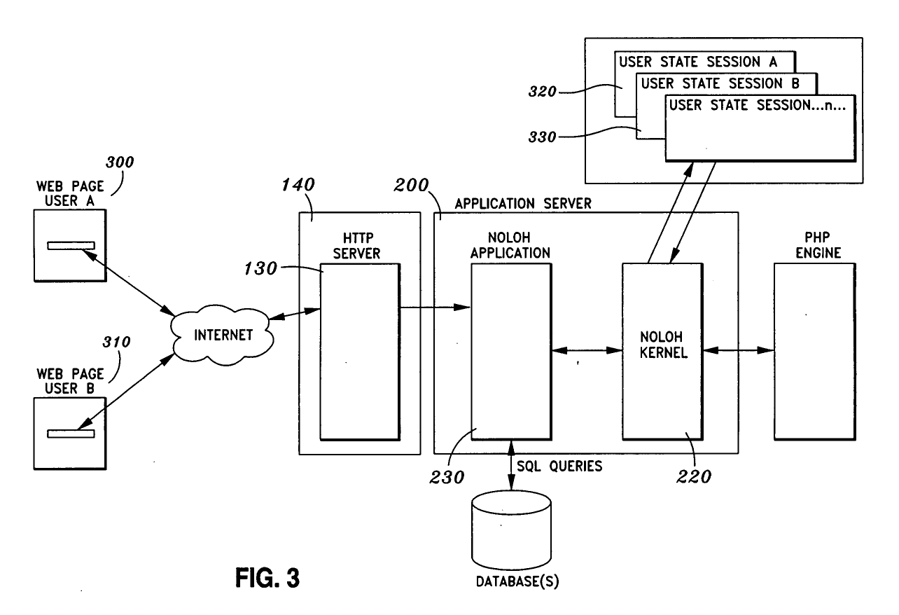

FIG. 3 illustrates another system for operating an interactive Web application according to the present invention. According another aspect of the invention, the scripting language interpreter engine 220 also manages state information for user sessions in a way that is transparent to the developers. As shown in FIG. 3, more than one users can interact with the Web application 230, for example, via User A Web page 300 and User B Web page 310. The session state information for User A 300 and User B 310, then, is maintained by the scripting language interpreter engine 220 in the corresponding session objects User A Session Object 320 and User B Session Object 330. The session state information are stored in the session objects and are retrieved as needed by the scripting language interpreter engine 220.

According to another aspect of the invention, the present invention is a system for developing interactive Web applications in a unified, single programming language framework. The programmers can develop the modular Web application 230 according to the present invention by developing one or more Web application modules written entirely in a scripting language. As discussed above, all of the code necessary to put together a Web page such as the HTML and JavaScript code are generated by the scripting language interpreter engine 220 when interpreting and executing the Web application module script code. Consequently, programmers need not deal with different syntax and rules of several programming languages in order to develop sophisticated interactive Web applications. Therefore, a unified framework utilizing a single programming language for developing interactive Web applications is provided.

Unlike the existing unified framework solutions, however, the present invention does not require the entire Web application to be loaded at the server at all times to be operational. As discussed above, the modular Web application 230 according to the present invention comprises one or more Web application modules that are loaded on-demand as required by the user requests from the clients. Thus, compared to the monolithic architecture approach of the existing solutions such as the J2EE and special purpose Application Servers, the modular Web application 230 of the present invention requires much less computing resources. In particular, there is no need to incur the large resource overhead to load the entire application even for relatively simple operations. As the result, the present invention provides a unified framework for developing and operating interactive Web applications that is light-weight, modular, and flexible.

In one embodiment, the scripting language interpreter engine 220 is written in the PHP language. In this embodiment, the system of the present invention also requires a PHP engine 240 to be operational. For information on the PHP language, see http://www.php.net/manual/en/.

The on-demand Web page generation feature of the present invention also enables on-demand loading and execution of client-side Web applications or applets. The existing technologies for creating client-side Web applications or applets such as the JavaScript or Macromedia Flash require the entire client application to be loaded to be operational. This requirement can translate to a significant resource requirement at the client machine, as the size and complexity of the client-side applications or applets increase. Such is the current trend fueled by the demand for more sophisticated and more interactive Web applications. The present invention, however, provides a novel solution to support very large client-side applications without requiring large computing resources on the client side by enabling on-demand loading and execution of client-side Web applications or applets.

As described above in detail, according to the present invention, each Web page is generated on-demand by the Web application 230. Utilizing this feature, the Web application 230 can generate only the code necessary to operate the particular Web page requested, including the operation of the client-side application or applet. Additional interactive features of the client-side application can be generated only when necessary in further interaction with the client. Thus, according to the present invention, a very large client-side application or applet can be supplied on-demand, a module at a time, without requiring the entire client-side application to be loaded to be operational. Therefore, very large client-side applications can be supported without requiring large computing resources on the client side.

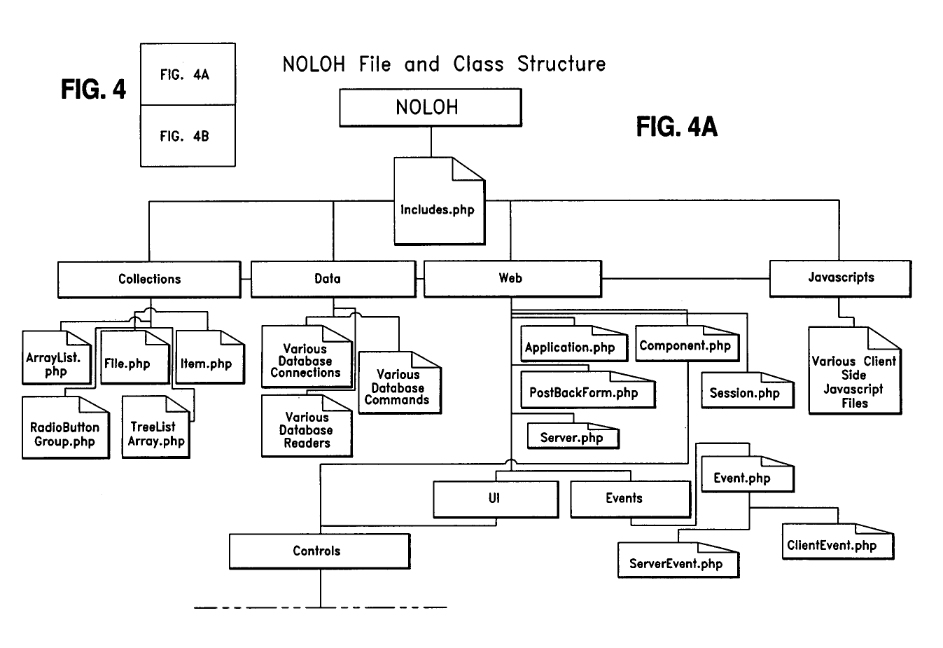

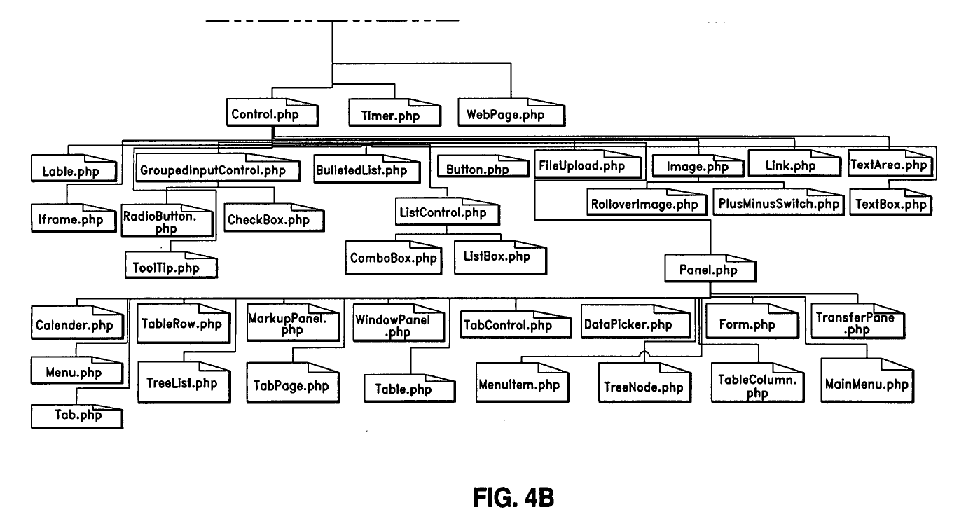

FIG. 4 illustrates the file and class structure of an interactive Web application according to the present invention. In one embodiment of the present invention, the scripting language is an object-oriented language. In a preferred embodiment, the scripting language of the present invention is the NOLOH programming language. NOLOH stands for “Not One Line Of HTML”. In fact, by utilizing the unified framework of the present invention, programmers need not write even a single line of HTML code to develop sophisticated interactive Web applications.

A language specification for the NOLOH language is given herein.

Language Specification

In the language specification provided herein, the scripting language of the present invention is referred to as the NOLOH language. The NOLOH language is built on the PHP language. As such, the basic language syntax of the NOLOH language is the same as the PHP language. For the specification for the PHP language, see: http://www.php.net/manual/en/.

For example, for both NOLOH and PHP languages, declaring a variable may be performed as shown in the following code examples:

class Foo
{

public $SomeVar;
function Foo( )
{
}

}
$someVar = new SomeThing( );
class Foo
{

public $SomeVar;
function Foo( )
{

$this−>SomeVar = new Something( );

}

}

The NOLOH language, however, has the ability to pass a parent to a child, unlike the PHP language. This feature of NOLOH is illustrated in the following code examples:

class SomethingElse
{

public $MyParent;
function SomethingElse($whatParent);
{

$this−>MyParent = $whatParent;

}

}
class Something
{

public $MyChild;
function Something( )
{

$this−>MyChild = new SomethingElse($this);

}

}

Furthermore, in the NOLOH language, if there is a Get or Set Function in a class, that function can be called as if it were a property of the class. This feature of NOLOH is illustrated in the following code examples:

class Foo
{

function Foo( )
{
}
function GetSelectedIndex( )
{
}
function SetSelectedIndex($SomeNumber)
{
}

}
function Something( )
{

$myVar = new Foo( );
// PHP allows this
$tempVar = $myVar−>GetSelectedIndex( );
// NOLOH also allows this
$tempVar = $myVar−>SelectedIndex;
// PHP allows this
$myVar−>SetSelectedIndex(2);
// NOLOH also allows this
$myVar−>SelectedIndex = 2;

}

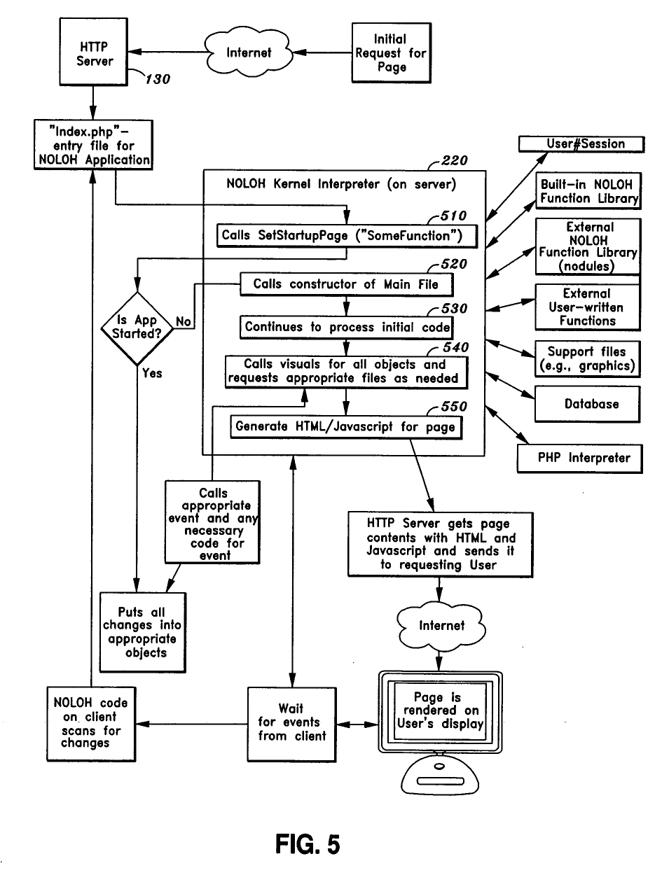

FIG. 5 illustrates the operation of the scripting language interpreter engine 220 in further detail. As shown in FIG. 5, the HTTP Server program 130 forwards the request for a Web page to the scripting language interpreter engine (SLIE) 220. Upon receiving the request for a Web page, the SLIE 220 executes a start-up function for the Web application module appropriate for the request in block 510. If the Web application module has not started previously, then the SLIE 220 executes the constructor for the Web application module in block 520. After executing the initialization code of the constructor in block 530, the SLIE 220 instantiates all objects and requests additional files or modules as necessary in block 540. Finally, all of the code necessary for the requested Web page, including HTML code and JavaScript code, are generated in block 550. If, on the other hand, the SLIE 220 determines that the Web application module has already started previously in block 510, the SLIE 220 proceeds to the steps in block 540 after putting in all necessary changes into all of the objects in the Web application module and processing all necessary events in the Web application module.

Furthermore, the SLIE 220 itself can be loaded on-demand according to the present invention. In one embodiment, the SLIE 220 is written in the PHP language. In this embodiment, the autoloading function of PHP 5 can be utilized to load the objects in the SLIE 220 only when they are needed.

According to another aspect of the invention, the present invention provides a novel method for generating a Web page where the JavaScript module code is hidden from view. With the existing Web technology, the source code for a Web page, including JavaScript code, can be viewed from a web browser by utilizing the view source function or a similar function for viewing the source code of a Web page. Thus, for the client-side Web applications utilizing JavaScript, the entire source code for the application can be viewed and copied by anyone through the view source function of a Web browser. This current state of affairs can be problematic for Web application developers who may not wish to expose the entire source code for their proprietary JavaScript applications or modules. The architecture of the present invention allows a novel approach to address this problem by providing a function to hide all JavaScript code from being viewed from a Web browser.

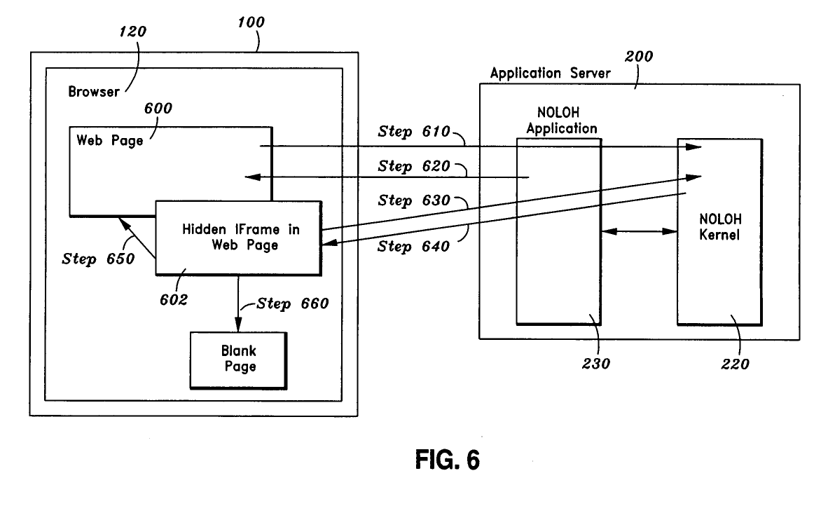

FIG. 6 illustrates the JavaScript hiding function according to the present invention. As shown in FIG. 6, the scripting language interpreter engine 220 running at the Web application server 200 receives a request for a Web page from a Web browser program 120 running at the Web client 100 (Step 610). Upon receiving the request for a Web page, the scripting language interpreter engine 220 loads on-demand the appropriate Web application module 230. As described above in detail, the Web application module 230 is interpreted and executed by the scripting language interpreter engine 220 to generate the requested Web page pulling together all of the files and code necessary for the Web page including the HTML source file, graphics files, and JavaScript code. The generated Web page is then sent to the Web browser program 120 running at the Web client 100 (Step 620). In one embodiment, the generated Web page also includes a hidden IFrame. As well known in the field of Web application development, an IFrame is an inline frame element in the HTML 4 specification that allows inserting a frame within a block of text of a Web page. For more information for IFrame, see: http://www.w3.org/TR/REC-html40/present/frames.html#h-16.5.

The Web page received at the Web client 100 is loaded onto the Web browser program 120, and is rendered as the Web page 600. Once the Web page 600 is loaded, the IFrame 602 of the Web page 600 sends a request for JavaScript code to the Web application server 200 (Step 630), which is then forwarded to the scripting language interpreter engine 220 running at the Web application server 200. Having received the request, the scripting language interpreter engine 220 determines that the request is for JavaScript code from the hidden IFrame at the Web client, not a request for a new Web page. Then, the requested JavaScript code is sent to the IFrame 602 at the Web browser program 120 running at the Web client 100 (Step 640). Note that the mechanism described herein is one specific example of on-demand loading of client-side applications or applets for the case of JavaScript applications or applets.

This on-demand modular loading of the client-side applications also enables JavaScript hiding capability according to the present invention. Once the requested JavaScript code is received by the IFrame 602, the IFrame 602 sends the JavaScript code to the main page of the Web page 600 (Step 650) which then evaluates the JavaScript code into memory. The IFrame 602 then direct itself to a blank page to clear out its memory of JavaScript code (Step 660). As the result, the JavaScript code is loaded onto the memory of the Web browser program 120 fully operational and ready to be executed, but the JavaScript code can no longer be viewed on the Web browser 120 via the view source function or analogous functions. Consequently, the proprietary JavaScript source code may be protected from being exposed to the public by utilizing the on-demand modular loading and execution feature of the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A system for developing interactive Web applications in a unified, single programming language framework, the system comprising:
a scripting language;
a scripting language interpreter engine for interpreting and executing code written in the scripting language; and
means for writing a modular Web application comprising one or more Web application modules written entirely in the scripting language,
wherein the modular Web application modules are loaded and executed on-demand by the scripting language interpreter engine at a Web application server to generate Web pages in response to Web page requests from a HTTP server.

2. The system of claim 1, wherein the scripting language is an object-oriented language.

3. The system of claim 1, wherein the scripting language interpreter engine is written in PHP language.

4. The system of claim 1, wherein generating Web pages include generating code for a module of a client-side application that is supplied on-demand to a Web client.

5. The system of claim 2, wherein the object-oriented scripting language is NOLOH language.

6. The system of claim 2, further comprising a class library of functions written in the object-oriented scripting language.

7. A system for operating interactive Web applications, comprising:
a scripting language interpreter engine at a Web application server for interpreting and executing code written in a scripting language; and
a modular Web application comprising one or more Web application modules written entirely in the scripting language,
wherein the scripting language interpreter engine loads, interprets, and executes the Web application modules on-demand to generate Web pages in response to Web page requests from a HTTP server.

8. The system of claim 7, further comprising:
a session manager within the scripting language interpreter engine for managing user state information.

9. The system of claim 7, wherein the scripting language interpreter engine is written in PHP language.

10. The system of claim 7, wherein the scripting language is an object-oriented language.

11. The system of claim 7, wherein generating Web pages include generating code for a module of a client-side application that is supplied on-demand to a Web client.

12. The system of claim 7, wherein the scripting language interpreter engine itself is loaded on-demand.

13. The system of claim 10, wherein the object-oriented scripting language is NOLOH language.

14. A method for developing interactive Web applications in a unified single programming language framework, the method comprising:
providing a scripting language;
providing a scripting language interpreter engine at a Web application server; and
writing a Web application comprising one or more Web application modules written entirely in the scripting language;
wherein the Web application modules are loaded and executed on-demand by the scripting language interpreter engine at the Web application server to generate Web pages in response to Web page requests from a HTTP server.

15. The method of claim 14, wherein the scripting language is an object-oriented language.

16. The method of claim 14, wherein the scripting language interpreter engine is written in PHP language.

17. The method of claim 14, wherein generating Web pages include generating code for a module of a client-side application that is supplied on-demand to a Web client.

18. The method of claim 15, wherein the object-oriented scripting language is NOLOH language.

19. The method of claim 15, further comprising:
providing a class library of functions written in the object-oriented scripting language.

20. A method for operating an interactive Web application comprising:
loading a scripting language interpreter engine at a Web application server for interpreting and executing code written in a scripting language;
loading a first Web application module at the Web application server wherein the first Web application module is written entirely in the scripting language;
forwarding a request for a Web page from a HTTP server to the first Web application module;
interpreting and executing with the scripting language interpreter engine script code within the first Web application module for handling the request for a Web page;
generating a first Web page in response to the request for a Web page from the HTTP server;
sending the generated first Web page to the HTTP server which then transmits the first Web page to a Web browser at a Web application client;
generating based on a first user input a client event within the first Web page at the Web application client;
servicing the client event at the Web application client;
generating based on a second user input a server event within the first Web page at the Web application client;
sending the server event to the HTTP server;
forwarding the server event from the HTTP server to the first Web application module at the Web application server;
interpreting and executing with the scripting language interpreter engine script code within the first Web application module for handling the server event;
loading a second Web application module at the Web application server on-demand as required by the interpreted script code, wherein the second Web application module is written entirely in the scripting language;
generating a second Web page at the Web application server in response to the server event; and
sending the generated second Web page to the HTTP server which then transmits the second Web page to the Web application client.

21. The method of claim 20, further comprising:
generating a session object within the scripting language interpreter engine for managing user state information;
storing user state information in the session object;
retrieving the user state information from the session object; and
using the user state information when generating the first and second Web pages.

22. The method of claim 20, wherein the interactive Web application comprises an entire Web site.

23. The method of claim 20, wherein the step of generating the first Web page at the Web application server in response to the server event include generating code for a module of a client-side application that is supplied on-demand to a Web client.

24. The method of claim 20, wherein the step of generating the second Web page at the Web application server in response to the server event include generating code for a module of a client-side application that is supplied on-demand to a Web client.

25. The method of claim 20, wherein the scripting language is an object-oriented language.

26. The method of claim 20, wherein the scripting language interpreter engine is written in PHP language.

27. The method of claim 20, wherein, in the step of loading a scripting language interpreter engine, the scripting language interpreter engine itself is loaded on-demand.

28. The method of claim 25, wherein the object-oriented scripting language is NOLOH language.

29. An application server for generating a Web page, the application server comprising:
an interpreter engine capable of receiving a request for the Web page and in response thereto loading on-demand an appropriate Web application module, which is a computer program coded in a scripting language which is the same scripting language interpreted by the interpreter engine, wherein the interpreter engine executes the Web application module and does so by interpreting the scripting language code such that different types of code are pulled together to generate the requested Web page.

30. A method for generating a Web page, the method comprising:
receiving a request for the Web page as an interpreter engine running at an application server;
loading on-demand an appropriate Web application module based on said request wherein the Web application module is a computer program coded in a scripting language which is the same scripting language interpreted by the interpreter engine; and
executing the Web application module by interpreting the scripting language code such that different types of code are pulled together to generate the requested Web page.

31. A system for operating an interactive Web application, comprising:
means for loading a scripting language interpreter engine at a Web application server for interpreting and executing code written in a scripting language;
means for loading a first Web application module at the Web application server wherein the first Web application module is written entirely in the scripting language;
means for forwarding a request for a Web page from a HTTP server to the first Web application module;
means for interpreting and executing with the scripting language interpreter engine script code within the first Web application module for handling the request for a Web page;
means for generating a first Web page in response to the request for a Web page from the HTTP server;
means for sending the generated first Web page to the HTTP server which then transmits the first Web page to a Web browser at a Web application client;
means for generating based on a first user input a client event within the first Web page at the Web application client;
means for servicing the client event at the Web application client;
means for generating based on a second user input a server event within the first Web page at the Web application client;
means for sending the server event to the HTTP server;
means for forwarding the server event from the HTTP server to the first Web application module at the Web application server;
means for interpreting and executing with the scripting language interpreter engine script code within the first Web application module for handling the server event;
means for loading a second Web application module at the Web application server on-demand as required by the interpreted script code, wherein the second Web application module is written entirely in the scripting language;
means for generating a second Web page at the Web application server in response to the server event; and
means for sending the generated second Web page to the HTTP server which then transmits the second Web page to the Web application client.

32. Computer-executable process steps for operating an interactive Web application, wherein the process steps are stored on a computer-readable medium, the steps comprising:
a step for loading a scripting language interpreter engine at a Web application server for interpreting and executing code written in a scripting language;
a step for loading a first Web application module at the Web application server wherein the first Web application module is written entirely in the scripting language;
a step for forwarding a request for a Web page from a HTTP server to the first Web application module;
a step for interpreting and executing with the scripting language interpreter engine script code within the first Web application module for handling the request for a Web page;
a step for generating a first Web page in response to the request for a Web page from the HTTP server;
a step for sending the generated first Web page to the HTTP server which then transmits the first Web page to a Web browser at a Web application client;
a step for generating based on a first user input a client event within the first Web page at the Web application client;
a step for servicing the client event at the Web application client;
a step for generating based on a second user input a server event within the first Web page at the Web application client;
a step for sending the server event to the HTTP server;
a step for forwarding the server event from the HTTP server to the first Web application module at the Web application server;
a step for interpreting and executing with the scripting language interpreter engine script code within the first Web application module for handling the server event;
a step for loading a second Web application module at the Web application server on-demand as required by the interpreted script code, wherein the second Web application module is written entirely in the scripting language;
a step for generating a second Web page at the Web application server in response to the server event; and
a step for sending the generated second Web page to the HTTP server which then transmits the second Web page to the Web application client.

33. A computer program product comprising code for:
running an interpretation engine at an application server, the engine comprising at least a language interpreter for a first scripting language;
receiving a request for a Web page and in response thereto;
loading on-demand a Web application module that is coded using the same first scripting language; and
executing said Web application module and interpreting the scripting language code such that different types of code are pulled together to generate the requested Web page.

34. A computer program comprising code to be executed on a computer for generating a Web page, the computer program having code for:
loading on-demand an appropriate Web application module depending on a request received for the Web page; and
executing the loaded Web application module, wherein the execution thereof is arranged to pull together different types of computer code for generating the Web page.

35. A method for generating a Web page including at least a JavaScript module, wherein the JavaScript module code is hidden from view, the method comprising:
receiving a request for a Web page from a Web client as an interpreter engine running at an application server;
loading on-demand an appropriate Web application module based on said request wherein the Web application module is a computer program coded in a scripting language which is the same scripting language interpreted by the interpreter engine;
executing the Web application module by interpreting the scripting language code such that different types of code are pulled together to generate the requested Web page, including at least a hidden IFrame;
sending the requested Web page to the Web client;
loading the Web page at the Web client;
requesting JavaScript code from the hidden IFrame at the Web client to the application server;
receiving the request for JavaScript code from the Web client at the interpreter engine running at the application server;
determining at the interpreter engine the request is for JavaScript code from the hidden IFrame at the Web client;
sending the requested JavaScript code to the Web client;
receiving the requested JavaScript code at the Web client;
sending the requested JavaScript code to the Web page, wherein the JavaScript code is loaded into memory; and
after the requested JavaScript code has been loaded into the memory of the Web page, deleting the JavaScript code from the hidden IFrame at the Web client.

36. A system for generating a Web page including at least a JavaScript module, wherein the JavaScript module code is hidden from view, the system comprising:
means for receiving a request for a Web page from a Web client as an interpreter engine running at an application server;
means for loading on-demand an appropriate Web application module based on said request wherein the Web application module is a computer program coded in a scripting language which is the same scripting language interpreted by the interpreter engine;
means for executing the Web application module by interpreting the scripting language code such that different types of code are pulled together to generate the requested Web page, including at least a hidden IFrame;
means for sending the requested Web page to the Web client;
means for loading the Web page at the Web client;
means for requesting JavaScript code from the hidden IFrame at the Web client to the application server;
means for receiving the request for JavaScript code from the Web client at the interpreter engine running at the application server;
means for determining at the interpreter engine the request is for JavaScript code from the hidden IFrame at the Web client;
means for sending the requested JavaScript code to the Web client;
means for receiving the requested JavaScript code at the Web client;
means for sending the requested JavaScript code to the Web page, wherein the JavaScript code is loaded into memory; and
means for deleting the JavaScript code from the hidden IFrame at the Web client after the requested JavaScript code has been loaded into the memory of the Web page.

37. Computer-executable process steps for generating a Web page including at least a JavaScript module, wherein the JavaScript module code is hidden from view, and wherein the process steps are stored on a computer-readable medium, the steps comprising:
a step for receiving a request for a Web page from a Web client as an interpreter engine running at an application server;
a step for loading on-demand an appropriate Web application module based on said request wherein the Web application module is a computer program coded in a scripting language which is the same scripting language interpreted by the interpreter engine;
a step for executing the Web application module by interpreting the scripting language code such that different types of code are pulled together to generate the requested Web page, including at least a hidden IFrame;
a step for sending the requested Web page to the Web client;
a step for loading the Web page at the Web client;
a step for requesting JavaScript code from the hidden IFrame at the Web client to the application server;
a step for receiving the request for JavaScript code from the Web client at the interpreter engine running at the application server;
a step for determining at the interpreter engine the request is for JavaScript code from the hidden IFrame at the Web client;
a step for sending the requested JavaScript code to the Web client;
a step for receiving the requested JavaScript code at the Web client;
a step for sending the requested JavaScript code to the Web page, wherein the JavaScript code is loaded into memory; and
a step for deleting the JavaScript code from the hidden IFrame at the Web client after the requested JavaScript code has been loaded into the memory of the Web page.

38. A computer program product for generating a Web page including at least a JavaScript module, wherein the JavaScript module code is hidden from view, the program product comprising code for:
receiving a request for a Web page from a Web client as an interpreter engine running at an application server;
loading on-demand an appropriate Web application module based on said request wherein the Web application module is a computer program coded in a scripting language which is the same scripting language interpreted by the interpreter engine;
executing the Web application module by interpreting the scripting language code such that different types of code are pulled together to generate the requested Web page, including at least a hidden IFrame;
sending the requested Web page to the Web client;
loading the Web page at the Web client;
requesting JavaScript code from the hidden IFrame at the Web client to the application server;
receiving the request for JavaScript code from the Web client at the interpreter engine running at the application server;
determining at the interpreter engine the request is for JavaScript code from the hidden IFrame at the Web client;
sending the requested JavaScript code to the Web client;
receiving the requested JavaScript code at the Web client;
sending the requested JavaScript code to the Web page, wherein the JavaScript code is loaded into memory; and
after the requested JavaScript code has been loaded into the memory of the Web page, deleting the JavaScript code from the hidden IFrame at the Web client.
